(19) United States
(12) Patent Application Publication
(10) Pub. No.: US 2025/0204570 A1
(43) Pub. Date: Jun. 26, 2025

(54) NON-ANIMAL PROTEIN COMPOSITIONS AND USES THEREOF

(71) Applicant: Firmenich SA, Satigny (CH)

(72) Inventors: Narendra Pratap Singh SISODIA, Satigny (CH); Ceren CADUN, Satigny (CH); Anubha GARG DINIS, Satigny (CH); Igor BODNAR, Satigny (CH)

(73) Assignee: Firmenich SA, Satigny (CH)

(21) Appl. No.: 18/847,746

(22) PCT Filed: Mar. 27, 2023
(86) PCT No.: PCT/EP2023/057813

§ 371 Date: Sep. 17, 2024

Related U.S. Application Data
(60) Provisional application No. 63/324,388, filed on Mar. 28, 2022.

(30) Foreign Application Priority Data
Mar. 31, 2022 (EP) 22166121.8

(51) Int. Cl. A23L 33/185; A23J 3/16; A23J 3/22; A23L 27/00; A23L 33/21

(52) U.S. Cl. CPC A23L 33/185; A23J 3/16; A23J 3/225; A23L 27/88; A23L 33/21

(57) ABSTRACT

The present disclosure relates generally to non-animal proteins and their use in various comestible products, such as food products, beverage products, and nutritional products, including meat and dairy analogue products. In some embodiments, the non-animal proteins include fava bean protein, mung bean protein, lentil protein, or combinations thereof. In some embodiments, the non-animal proteins are combined with other non-animal proteins, such as soy protein or pea protein, to compliment the amino acid profile of the resulting blend. In some embodiments. The non-animal proteins are combined with certain fibers, which allows the blend to be suitable for addition to an ingestible composition useful for making meat or dairy analogue products. In some embodiments, flavorings or flavor-modifiers are combined with the non-animal proteins as well.

### TECHNICAL FIELD

The present disclosure relates generally to non-animal proteins and their use in various comestible products, such as food products, beverage products, and nutritional products, including meat and dairy analogue products. In some embodiments, the non-animal proteins include fava bean protein, mung bean protein, lentil protein, or combinations thereof. In some embodiments, the non-animal proteins are combined with other non-animal proteins, such as soy protein or pea protein, to compliment the amino acid profile of the resulting blend. In some embodiments, The non-animal proteins are combined with certain fibers, which allows the blend to be suitable for addition to an ingestible composition useful for making meat or dairy analogue products. In some embodiments, flavorings or flavor-modifiers are combined with the non-animal proteins as well.

### DESCRIPTION OF RELATED ART

The human diet generally includes both animal-derived and non-animal-derived products. In recent years, the proportion of calories consumed from animal-derived products has increased. This poses certain health-related concerns, as eating too much meat, especially meats high in fat and cholesterol, tends to contribute to heart disease and related problems. Another concern relates to sustainability. Raising animals for meat often requires large amounts of grain or grass to use as animal feed. It requires many times more acres of land to grow the grass or grain to feed such animals than it would to grow plants for direct human consumption. Thus, as the global population continues to increase, the demand for increasing agricultural space becomes steadily unsustainable.

Thus, there is increasing demand to replace meat in the human diet with similar materials derived from plants, algae, fungi, and the like. In many cases, because consumers have become accustomed to consuming meat, these non-animal-based alternative foods are designed to simulate the flavor, texture, and culinary experience of consuming meat. But creating such meat analogue materials poses a number of challenges, as one attempts to use plant-derived materials to create a food product that simulates eating meat.

One such challenge involves simulating the protein profile and flavor of animal proteins using proteins derived from non-animal sources. For example, pea protein is often used to make plant-based alternatives to meat products. But pea protein can impart undesirable off notes and may even have undesirably low quantities of certain amino acids in comparison to meat products. Taste maskers and certain flavorings can be used to address the former problem, but such compounds do little to diversify the amino acid profile of the protein. So, although the taste is improved, the resulting product may have reduced protein quality in comparison to animal-based alternatives.

Therefore, there is a continuing need to develop non-animal-based materials that better simulate the taste and nutritional profile of animal proteins.

### SUMMARY

The present disclosure relates to the discovery of certain protein blends provide an improved flavor profile or an improved amino acid profile, particularly when used in applications such as dairy and meat analogues.

In a first aspect, the disclosure provides uses of a protein additive composition to (a) improve the flavor or aroma of, or (b) improve the amino acid profile of, an ingestible composition; wherein the ingestible composition comprises pea protein, soy protein, or a combination thereof; and wherein the protein additive composition comprises at least one non-animal protein besides pea protein or soy protein. In certain related methods, the disclosure provided methods of (a) improving the flavor of, or (b) improving the amino acid profile of, an ingestible composition, comprising introducing a protein additive composition to the ingestible composition; wherein the ingestible composition comprises pea protein, soy protein, or a combination thereof; and wherein the protein additive composition comprises at least one non-animal protein besides pea protein or soy protein.

In a second aspect, the disclosure provides an ingestible composition, which comprises: (a) pea protein, soy protein, or a combination thereof; and (b) at least one additional non-animal protein; and (c) optionally, a flavoring. In some embodiments, the ingestible composition further comprises a fiber component.

In a third aspect, the disclosure provides a flavored product comprising an ingestible composition of the second aspect. In some embodiments, the flavored product is a beverage product, such as a dairy or dairy analogue product. In some other embodiments, the flavored product is a food products, such as yogurt or a meat analogue product, such as a chicken analogue product, a beef analogue product, or the like. In some embodiments, the flavored products are animal feed product, such as a cat feed or dog feed product.

Further aspects, and embodiments thereof, are set forth below in the Detailed Description, the Abstract, and the Claims.

### DETAILED DESCRIPTION

The following Detailed Description sets forth various aspects and embodiments provided herein. The description is to be read from the perspective of the person of ordinary skill in the relevant art. Therefore, information that is well known to such ordinarily skilled artisans is not necessarily included.

### Definitions

The following terms and phrases have the meanings indicated below, unless otherwise provided herein. This disclosure may employ other terms and phrases not expressly defined herein. Such other terms and phrases have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary

As used herein, “sweetener,” “sweet flavoring agent,” “sweet flavor entity,” or “sweet compound” all refer to a compound or a comestibly acceptable salt thereof that elicits a detectable sweet flavor in a subject, such as a compound that activates a human T1R2 or T1R3 receptor in the course of in vitro screening or that is reported to be sweet via sensory evaluation by human subjects.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure, and are not meant to be limiting in any fashion. Nor do these phrases indicate any kind of preference for the disclosed embodiment.

As used herein, “comprise” or “comprises” or “comprising” or “comprised of” refer to groups that are open, meaning that the group can include additional members in addition to those expressly recited. For example, the phrase, “comprises A” means that A must be present, but that other members can be present too. The terms “include,” “have,” and “composed of” and their grammatical variants have the same meaning. In contrast, “consist of” or “consists of” or “consisting of” refer to groups that are closed. For example, the phrase “consists of A” means that A and only A is present.

As used herein, “optionally” means that the subsequently described event(s) may or may not occur. In some embodiments, the optional event does not occur. In some other embodiments, the optional event does occur one or more times.

As used herein, “or” is to be given its broadest reasonable interpretation, and is not to be limited to an either/or construction. Thus, the phrase “comprising A or B” means that A can be present and not B, or that B is present and not A, or that A and B are both present. Further, if A, for example, defines a class that can have multiple members, e.g., A1 and A2, then one or more members of the class can be present concurrently.

Other terms are defined in other portions of this description, even though not included in this subsection.

### Protein Additive Compositions and Their Use

In certain aspects, the disclosure provides use of a protein additive composition to (a) improve the flavor or aroma of, or (b) improve the amino acid profile of, an ingestible composition; wherein the ingestible composition comprises pea protein, soy protein, or a combination thereof; and wherein the protein additive composition comprises at least one non-animal protein besides pea protein or soy protein. In certain related methods, the disclosure methods of (a) improving the flavor of, or (b) improving the amino acid profile of, an ingestible composition, comprising introducing a protein additive composition to the ingestible composition; wherein the ingestible composition comprises pea protein, soy protein, or a combination thereof; and wherein the protein additive composition comprises at least one non-animal protein besides pea protein or soy protein.

As noted above, the protein additive composition comprises at least one non-animal protein besides pea protein or soy protein. In general, these compositions are used to offset certain shortcomings of pea or soy proteins, so there is no reason to include pea or soy protein in the composition. Thus, in some embodiments, the protein additive composition is free of both pea protein and soy protein. In some embodiments, the protein additive composition is free of animal proteins. In some such embodiments, the proteins in the protein additive composition are plant proteins, mycoproteins, algal proteins, or any combination thereof. In some further such embodiments, the proteins in the protein additive composition are plant proteins. In some embodiments, the protein additive composition comprises fava bean protein, mung bean protein, sunflower seed protein, red lentil protein, oat protein, canola protein, or any combinations thereof.

The protein additive compositions can contain certain other components that may be beneficially used in food or beverage products, particularly dairy and meat analogue products. For example, in some embodiments, the protein additive composition comprises one or more fibers, such as plant-based fibers. Various fibers suitable for use in the protein additive composition are described in further detail below in a section devoted to fibers. In some embodiments, the protein additive composition comprises one or more flavorings or tastants, including taste various compounds that modify taste or aroma. These compounds are described in further detail below. The protein additive composition can also include any number of other excipients, such as a carrier, a bulking agent, a desiccant, and the like, as described in further detail below.

As noted above, in some aspects and embodiments thereof, the protein additive composition is used to improve the flavor or aroma of, or improve the amino acid profile of, an ingestible composition that comprises pea or soy protein. In some embodiments, the protein additive composition is used to improve the flavor or aroma of an ingestible composition that comprises pea or soy protein. Pea and soy proteins are often perceived as having certain characteristics that consumers find unpleasant. These include a green vegetal taste, a green vegetal aroma, a bitter taste, an absence of sweetness, a cereal taste, an astringent taste, a lack of perceived juiciness, an undesirable mouthfeel, and a lack of saltiness. Thus, in some embodiments, to improve the flavor or aroma of an ingestible is to reduce a green vegetal taste of the ingestible composition. In some embodiments, to improve the flavor or aroma of an ingestible is to reduce a green vegetal aroma of the ingestible composition. In some embodiments, to improve the flavor or aroma of an ingestible is to reduce a bitter taste of the ingestible composition. In some embodiments, to improve the flavor or aroma of an ingestible is to reduce a cereal taste of the ingestible composition. In some embodiments, to improve the flavor or aroma of an ingestible is to enhance a sweet taste of the ingestible composition. In some embodiments, to improve the flavor or aroma of an ingestible is to enhance a salty taste of the ingestible composition. In some embodiments, to improve the flavor or aroma of an ingestible is to reduce an astringent taste of the ingestible composition. In some embodiments, to improve the flavor or aroma of an ingestible is to enhance a mouthfeel of the ingestible composition. In some embodiments, to improve the flavor or aroma of an ingestible is to enhance a perceived juiciness of the ingestible composition. In some other embodiments, the protein additive composition is used to improve the amino acid profile of an ingestible composition that comprises pea or soy protein. In some such embodiments, to improve the amino acid profile of an ingestible composition is to increase the content of cysteine or methionine in the ingestible composition. In some such embodiments, to improve the amino acid profile of an ingestible composition is to increase the content of isoleucine in the ingestible composition. In some such embodiments, to improve the amino acid profile of an ingestible composition is to increase the content of phenylalanine or tyrosine in the ingestible composition.

### Ingestible Compositions

Various aspects, and embodiments thereof, disclosed herein refer to ingestible compositions. In some cases, the ingestible compositions include the protein additive compositions, and, in other cases, the protein additive composition is introduced to the ingestible composition.

The ingestible compositions comprise pea protein, soy protein, or a combination thereof. In some embodiments, the ingestible composition comprises pea protein. In some other embodiments, the ingestible composition comprises soy protein. In some other embodiments, the ingestible composition comprises a blend of pea protein and soy protein.

The ingestible comprises or has introduced to it at least one non-animal protein besides pea protein or soy protein. In some such embodiments, this additional non-animal protein is a plant protein, a mycoprotein, an algal protein, or any combination thereof. In some further such embodiments, the additional non-animal protein is a plant protein. In some such embodiments, the additional non-animal protein is fava bean protein, mung bean protein, sunflower seed protein, red lentil protein, oat protein, or any combinations thereof. These additional non-animal proteins can be added to the ingestible composition in any suitable ratio relative to pea or soy protein. In some embodiments, the weight ratio of pea protein and soy protein (combined) to the additional non-animal protein in the ingestible composition ranges from 1:1 to 20:1, or from 2:1 to 10:1. In some embodiments, the pea protein and soy protein (combined) make up from 50% by weight to 99% by weight, or from 60% by weight to 95% by weight, or from 70% by weight to 90% by weight, of the ingestible composition, based on the total weight of non-animal protein in the ingestible composition. In some embodiments, the additional non-animal protein(s) make up from 1% by weight to 50% by weight, or from 5% by weight to 40% by weight, or from 10% by weight to 30% by weight, of the ingestible composition, based on the total weight of non-animal protein in the ingestible composition.

The ingestible composition can include a number of other ingredients. These additional ingredients can be part of the ingestible composition, or can be introduced to the ingestible composition via introduction of the protein supplement composition, as described above.

### Other Non-Animal Proteins

In addition to the non-animal proteins described above, the ingestible composition, or the protein supplement composition, include, in some embodiments, additional non-animal proteins.

These other non-animal proteins include, without limitation, plant proteins, algal proteins, mycoproteins, or combinations thereof. In some embodiments, The other non-animal proteins are plant-based protein. Non-limiting examples of such plant proteins include hemp protein, almond protein, cashew protein, canola (rapeseed) protein, chickpea protein, wheat protein, potato protein, lupine, and rice protein. The other non-animal proteins can make up any suitable proportion of the ingestible composition. For example, in some embodiments, the other non-animal protein makes up from 1 percent by weight to 50 percent by weight, or from 1 percent by weight to 40 percent by weight, or from 1 percent by weight to 30 percent by weight, or from 1 percent by weight to 20 percent by weight, based on the total weight of non-animal protein in the ingestible composition.

### Fibers

The ingestible composition, or the protein supplement composition, include, in some embodiments, one or more fibers. Such fibers are generally plant-derived and include both soluble and insoluble fibers.

As used herein, the term “soluble fiber” refers to polysaccharides characterized as being soluble by using the method of the Association of Official Analytical Chemists (AOAC) and as set forth in Prosky et al., J. ASSOC. OFF. ANAL. CHEM., vol. 70 (5), pp. 1017-1023 (1988). Any suitable soluble fibers can be used, including, but not limited to, fruit fiber (such as citrus fiber), grain fibers, psyllium husk fiber, natural soluble fibers and synthetic soluble fibers. Natural fibers include soluble corn fiber, maltodextrin, acacia, and hydrolyzed guar gum. Synthetic soluble fibers include polydextrose, modified food starch, and the like. Non-limiting examples of food-grade sources of soluble fiber include inulin, corn fiber, barley fiber, corn germ, ground oat hulls, milled corn bran, derivatives of the aleurone layer of wheat bran, flax flour, whole flaxseed bran, winter barley flake, ground course kilned oat groats, maize, pea fiber (e.g. Canadian yellow pea), Danish potatoes, konjac vegetable fiber (glucomannan), psyllium fiber from seed husks of planago ovate, psyllium husk, liquid agave fiber, rice bran, oat sprout fibers, amaranth sprout, lentil flour, grape seed fiber, apple, blueberry, cranberry, fig fibers, ciranda power, carob powder, milled prune fiber, mango fiber, apple fiber, orange, orange pulp, strawberry, carrageenan hydrocolloid, derivatives of eucheuma cottonnil seaweed, cottonseed, soya, kiwi, acacia gum fiber, bamboo, chia, potato, potato starch, pectin (carbohydrate) fiber, hydrolyzed guar gum, carrot, soy, soybean, chicory root, oat, wheat, tomato, polydextrose fiber, refined corn starch syrup, isomalto-oligosaccharide mixtures, soluble dextrin, mixtures of citrus bioflavonoids, cell-wall broken nutritional yeast, lipophilic fibers, plum juice, derivatives from larch trees, olygose fibers, derivatives from cane sugar, short-chain fructooligosaccharides, synthetic polymers of glucose, polydextrose, pectin, polanion compounds, cellulose fibers, cellulose fibers derived from hard wood plants and carboxymethyl cellulose.

In some embodiments, the ingestible composition or the protein additive composition can also include certain insoluble fibers, which can provide structure and texture to the ingestible composition. Any suitable insoluble fiber can be used. In some embodiments, the insoluble fiber is a plant-derived fiber. Non-limiting examples include nut fibers, grain fibers, rice fibers, seed fibers, oat fibers, pea fibers, potato fibers, berry fibers, soybean fibers, banana fibers, citrus fibers, apple fibers, and carrot fibers. In some embodiments, the insoluble fiber is pea fiber.

In some embodiments, the ingestible composition comprises pea fiber, citrus fiber, potato fiber, psyllium fiber, acacia fiber, inulin, konjac fiber, or any combination thereof.

The fiber can make up any suitable proportion of the ingestible composition. For example, in some embodiments, the fiber makes up from 1% by weight to 50% by weight, or from 1% by weight to 40% by weight, or from 1% by weight to 30% by weight, or from 1% by weight to 20% by weight, or from 3% by weight to 50% by weight, or from 3% by weight to 40% by weight, or from 3% by weight to 30% by weight, or from 3% by weight to 20% by weight, based on the total dry weight of the ingestible composition.

### Flavorings, Extracts, and Flavor and Aroma Modifiers

The ingestible composition, or the protein supplement composition, include, in some embodiments, one or more flavorings, extracts, flavor modifiers, aroma modifiers, or any combination thereof.

The comestible compositions disclosed herein comprise a flavoring. In general, the flavoring improves the taste and flavor of the ingestible composition or the resulting flavored product in which the ingestible composition is used. Such improvement includes reducing the bitterness of the ingestible composition or the resulting flavored product, reducing the perception of astringency of the ingestible composition or the resulting flavored product, reducing the perception of green taste notes (such as pea taste) of the ingestible composition or the resulting flavored product, reducing the perception of cereal notes of the ingestible composition or the resulting flavored product, improving the perception of creaminess of the ingestible composition or the resulting flavored product, improving the perception of fattiness of the ingestible composition or the resulting flavored product, improving the perception of sweetness of the ingestible composition or the resulting flavored product, improving the perception of savory taste (umami or kokumi) of the ingestible composition or the resulting flavored product, improving the mouthfeel or mouthcoating of the ingestible composition or the resulting flavored product, improving the perception of juiciness of the ingestible composition or the resulting flavored product, improving the perception of thickness of the ingestible composition or the resulting flavored product.

Any suitable flavoring can be used. In some embodiments, the flavoring comprises synthetic flavor oils and flavoring aromatics or oils, oleoresins and extracts derived from plants, leaves, flowers, fruits, and so forth, or combinations thereof. Non-limiting examples of flavor oils include spearmint oil, cinnamon oil, oil of wintergreen (methyl salicylate), peppermint oil, Japanese mint oil, clove oil, bay oil, anise oil, eucalyptus oil, thyme oil, cedar leaf oil, oil of nutmeg, allspice, oil of sage, mace, oil of bitter almonds, and cassia oil. Non-limiting examples of other flavors include natural and synthetic fruit flavors such as vanilla, and citrus oils including lemon, orange, lime, grapefruit, yazu, sudachi, and fruit essences including apple, pear, peach, grape, blueberry, strawberry, raspberry, cherry, plum, pineapple, watermelon, apricot, banana, melon, apricot, ume, cherry, raspberry, blackberry, tropical fruit, mango, mangosteen, pomegranate, papaya and so forth. Other potential flavors include a milk flavor, a butter flavor, a cheese flavor, a cream flavor, and a yogurt flavor; a vanilla flavor; tea or coffee flavors, such as a green tea flavor, a oolong tea flavor, a tea flavor, a cocoa flavor, a chocolate flavor, and a coffee flavor; mint flavors, such as a peppermint flavor, a spearmint flavor, and a Japanese mint flavor; spicy flavors, such as an asafetida flavor, an ajowan flavor, an anise flavor, an angelica flavor, a fennel flavor, an allspice flavor, a cinnamon flavor, a chamomile flavor, a mustard flavor, a cardamom flavor, a caraway flavor, a cumin flavor, a clove flavor, a pepper flavor, a coriander flavor, a sassafras flavor, a savory flavor, a zanthoxyli fructus flavor, a perilla flavor, a juniper berry flavor, a ginger flavor, a star anise flavor, a horseradish flavor, a thyme flavor, a tarragon flavor, a dill flavor, a capsicum flavor, a nutmeg flavor, a basil flavor, a marjoram flavor, a rosemary flavor, a bayleaf flavor, and a wasabi (Japanese horseradish) flavor; alcoholic flavors, such as a wine flavor, a whisky flavor, a brandy flavor, a rum flavor, a gin flavor, and a liqueur flavor; floral flavors; and vegetable flavors, such as an onion flavor, a garlic flavor, a cabbage flavor, a carrot flavor, a celery flavor, mushroom flavor, and a tomato flavor. These flavoring agents may be used in liquid or solid form and may be used individually or in admixture. In the context of dairy or dairy analog products, the most commonly used flavor agents are agents that impart flavors such as vanilla, French vanilla, chocolate, banana, lemon, hazelnut, coconut, almond, strawberry, mocha, coffee, tea, chai, cinnamon, caramel, cream, brown sugar, toffee, pecan, butter pecan, toffee, Irish crème, white chocolate, raspberry, pumpkin pie spice, peppermint, or any combination thereof.

In some embodiments, the flavoring is a flavoring that provides a meat or savory tonality, including flavorings or tonalities of beef, lamb, bison, smoke, pork, bacon, ham, sausage, chicken, turkey, goose, duck, mushroom, celery, tomato, onion, garlic, carrot, leek, fish, shellfish, soy, miso, and the like. In some further embodiments, the flavoring comprises one or more lactones, which impart a creamy flavor to the ingestible composition.

In some embodiments, the flavoring comprises a yeast extract, such as a yeast lysate. Such extracts can be obtained from any suitable yeast strain, where such extracts are suitable for human consumption. Non-limiting examples of such yeasts include: yeasts of the genus Saccharomyces, such as Saccharomyces cerevisiae or Saccharomyces pastorianus; yeasts of the genus Candida, such as Candida utilis; yeasts of the genus Kluyveromyces, such as Kluyveromyces lactis or Kluyveromyces marxianus; yeasts of the genus Pichia such as Pichia pastoris; yeasts of the genus Debaryomyces such as Debaryomyces hansenii; and yeasts of the genus Zygosaccharomyces such as Zygosaccharomyces mellis. In some embodiments, the yeast is a yeast collected after brewing beer, sake, or the like. In some embodiments, the yeast is a yeast subjected to drying treatment (dried yeast) after collection.

Such extracts can be produced by any suitable means. In general, yeast extracts or lysates are made by extracting the contents of the yeast cells from the cell wall material. In many instances, the digestive enzymes in the cells (or additional enzymes added to the composition) break down the proteins and polynucleotides in the yeast to amino acids, oligopeptides (for example, from 2 to 10 peptides), nucleotides, oligonucleotides (from 2 to 10 nucleotides), and mixtures thereof. A yeast lysate can be prepared by lysing a yeast. For example, in some embodiments, the yeast after culture is crushed or lysed by an enzymatic decomposition method, a self-digestion method, an alkaline extraction method, a hot water extraction method, an acid decomposition method, an ultrasonic crushing method, crushing with a homogenizer, a freezing-thawing method, or the like (two or more thereof may be used in combination), whereby a yeast lysate is obtained. Yeast may be cultured by a conventional method. In some embodiments, the yeast after culture is heat-treated and then treated with a lytic enzyme to obtain an enzyme lysate. The conditions for the heat treatment are, for example, 80° C. to 90° C. for 5 minutes to 30 minutes. As the lytic enzyme used for the enzymatic decomposition method, various enzymes can be used as long as they can lyse the cell wall of yeast. The reaction conditions may be set so as to be optimum or suitable for the lytic enzyme(s) to be used, and specific examples thereof can include a temperature of 50° C. to 60° C., and a pH of 7.0 to 8.0. The reaction time is also not particularly limited, and can be, for example, 3 hours to 5 hours.

Compositions comprising yeast lysate can be obtained from a variety of commercial sources. For example, in some embodiments, the yeast lysate is provides by the flavoring additive sold under the name MODUMAX (DSM Food Specialties BV, Delft, Netherlands).

The flavoring also includes, in certain embodiments, one or more additional flavor-modifying compounds, such as compounds that enhance sweetness (e.g., phloretin, naringenin, glucosylated steviol glycosides, etc.), compounds that block bitterness, compounds that enhance umami, compounds that enhance kokumi, compounds that reduce sourness or licorice taste, compounds that enhance saltiness, compounds that enhance a cooling effect, compounds that enhance mouthfeel, or any combinations of the foregoing.

In some embodiments, the ingestible composition comprises a sweetener. The sweetener can be present in any suitable concentration, depending on factors such as the sweetener's potency as a sweetener, its solubility, and the like.

In general, the ingestible compositions disclosed herein can include any suitable sweeteners or combination of sweeteners. In some embodiments, the sweetener is a common saccharide sweeteners, such as sucrose, fructose, glucose, and sweetener compositions comprising natural sugars, such as corn syrup (including high fructose corn syrup) or other syrups or sweetener concentrates derived from natural fruit and vegetable sources. In some embodiments, the sweetener is sucrose, fructose, or a combination thereof. In some embodiments, the sweetener is sucrose. In some other embodiments, the sweetener is selected from rare natural sugars including D-allose, D-psicose, L-ribose, D-tagatose, L-glucose, L-fucose, L-arbinose, D-turanose, and D-leucrose. In some embodiments, the sweetener is selected from semi-synthetic “sugar alcohol” sweeteners such as erythritol, isomalt, lactitol, mannitol, sorbitol, xylitol, maltodextrin, and the like. In some embodiments, the sweetener is selected from artificial sweeteners such as aspartame, saccharin, acesulfame-K, cyclamate, sucralose, and alitame. In some embodiments, the sweetener is selected from the group consisting of cyclamic acid, mogroside, tagatose, maltose, galactose, mannose, sucrose, fructose, lactose, allulose, neotame and other aspartame derivatives, glucose, D-tryptophan, glycine, maltitol, lactitol, isomalt, hydrogenated glucose syrup (HGS), hydrogenated starch hydrolyzate (HSH), stevioside, rebaudioside A, other sweet Stevia-based glycosides, chemically modified steviol glycosides (such as glucosylated steviol glycosides), mogrosides, chemically modified mogrosides (such as glucosylated mogrosides), carrelame and other guanidine-based sweeteners. In some embodiments, the additional sweetener is a combination of two or more of the sweeteners set forth in this paragraph. In some embodiments, the sweetener may combinations of two, three, four or five sweeteners as disclosed herein. In some embodiments, the additional sweetener is a sugar. In some embodiments, the additional sweetener is a combination of one or more sugars and other natural and artificial sweeteners. In some embodiments, the additional sweetener is a sugar. In some embodiments, the sugar is cane sugar. In some embodiments, the sugar is beet sugar. In some embodiments, the sugar may be sucrose, fructose, glucose or combinations thereof. In some embodiments, the sugar is sucrose. In some embodiments, the sugar is a combination of fructose and glucose.

In some embodiments, the sweeteners can also include, for example, sweetener compositions comprising one or more natural or synthetic carbohydrate, such as corn syrup, high fructose corn syrup, high maltose corn syrup, glucose syrup, sucralose syrup, hydrogenated glucose syrup (HGS), hydrogenated starch hydrolyzate (HSH), or other syrups or sweetener concentrates derived from natural fruit and vegetable sources, or semi-synthetic “sugar alcohol” sweeteners such as polyols. Non-limiting examples of polyols in some embodiments include erythritol, maltitol, mannitol, sorbitol, lactitol, xylitol, isomalt, propylene glycol, glycerol (glycerin), threitol, galactitol, palatinose, reduced isomalto-oligosaccharides, reduced xylo-oligosaccharides, reduced gentio-oligosaccharides, reduced maltose syrup, reduced glucose syrup, isomaltulose, maltodextrin, and the like, and sugar alcohols or any other carbohydrates or combinations thereof capable of being reduced which do not adversely affect taste.

The sweetener may be a natural or synthetic sweetener that includes, but is not limited to, agave inulin, agave nectar, agave syrup, amazake, brazzein, brown rice syrup, coconut crystals, coconut sugars, coconut syrup, date sugar, fructans (also referred to as inulin fiber, fructo-oligosaccharides, or oligo-fructose), green stevia powder, Stevia rebaudiana, rebaudioside A, rebaudioside B, rebaudioside C, rebaudioside D, rebaudioside E, rebaudioside F, rebaudioside I, rebaudioside H, rebaudioside L, rebaudioside K, rebaudioside J, rebaudioside N, rebaudioside O, rebaudioside M and other sweet stevia-based glycosides, stevioside, stevioside extracts, honey, Jerusalem artichoke syrup, licorice root, luo han guo (fruit, powder, or extracts), lucuma (fruit, powder, or extracts), maple sap (including, for example, sap extracted from Acer saccharum, Acer nigrum, Acer rubrum, Acer saccharinum, Acer platanoides, Acer negundo, Acer macrophyllum, Acer grandidentatum, Acer glabrum, Acer mono), maple syrup, maple sugar, walnut sap (including, for example, sap extracted from Juglans cinerea, Juglans nigra, Juglans ailatifolia, Juglans regia), birch sap (including, for example, sap extracted from Betula papyrifera, Betula alleghaniensis, Betula lenta, Betula nigra, Betula populifolia, Betula pendula), sycamore sap (such as, for example, sap extracted from Platanus occidentalis), ironwood sap (such as, for example, sap extracted from Ostrya virginiana), mascobado, molasses (such as, for example, blackstrap molasses), molasses sugar, monatin, monellin, cane sugar (also referred to as natural sugar, unrefined cane sugar, or sucrose), palm sugar, panocha, piloncillo, rapadura, raw sugar, rice syrup, sorghum, sorghum syrup, cassava syrup (also referred to as tapioca syrup), thaumatin, yacon root, malt syrup, barley malt syrup, barley malt powder, beet sugar, cane sugar, crystalline juice crystals, caramel, carbitol, carob syrup, castor sugar, hydrogenated starch hydrolates, hydrolyzed can juice, hydrolyzed starch, invert sugar, anethole, arabinogalactan, arrope, syrup, P-4000, acesulfame potassium (also referred to as acesulfame K or ace-K), alitame (also referred to as aclame), advantame, aspartame, baiyunoside, neotame, benzamide derivatives, bernadame, canderel, carrelame and other guanidine-based sweeteners, vegetable fiber, corn sugar, coupling sugars, curculin, cyclamates, cyclocarioside I, demerara, dextran, dextrin, diastatic malt, dulcin, sucrol, valzin, dulcoside A, dulcoside B, emulin, enoxolone, maltodextrin, saccharin, estragole, ethyl maltol, glucin, gluconic acid, glucono-lactone, glucosamine, glucoronic acid, glycerol, glycine, glycyphillin, glycyrrhizin, glycyrrhetic acid monoglucuronide, golden sugar, yellow sugar, golden syrup, granulated sugar, gynostemma, hernandulcin, isomerized liquid sugars, jallab, chicory root dietary fiber, kynurenine derivatives (including N′-formyl-kynurenine, N′-acetyl-kynurenine, 6-chloro-kynurenine), galactitol, litesse, ligicane, lycasin, lugduname, guanidine, falernum, mabinlin I, mabinlin II, maltol, maltisorb, maltodextrin, maltotriol, mannosamine, miraculin, mizuame, mogrosides (including, for example, mogroside IV, mogroside V, and neomogroside), mukurozioside, nano sugar, naringin dihydrochalcone, neohesperidine dihydrochalcone, nib sugar, nigero-oligosaccharide, norbu, orgeat syrup, osladin, pekmez, pentadin, periandrin I, perillaldehyde, perillartine, petphyllum, phenylalanine, phlomisoside I, phlorodizin, phyllodulcin, polyglycitol syrups, polypodoside A, pterocaryoside A, pterocaryoside B, rebiana, refiners syrup, rub syrup, rubusoside, selligueain A, shugr, siamenoside I, siraitia grosvenorii, soybean oligosaccharide, Splenda, SRI oxime V, steviol glycoside, steviolbioside, stevioside, strogins 1, 2, and 4, sucronic acid, sucrononate, sugar, suosan, phloridzin, superaspartame, tetrasaccharide, threitol, treacle, trilobtain, tryptophan and derivatives (6-trifluoromethyl-tryptophan, 6-chloro-D-tryptophan), vanilla sugar, volemitol, birch syrup, aspartame-acesulfame, assugrin, and combinations or blends of any two or more thereof.

In still other embodiments, the sweetener can be a chemically or enzymatically modified natural high potency sweetener. Modified natural high potency sweeteners include glycosylated natural high potency sweetener such as glucosyl-, galactosyl-, or fructosyl-derivatives containing 1-50 glycosidic residues. Glycosylated natural high potency sweeteners may be prepared by enzymatic transglycosylation reaction catalyzed by various enzymes possessing transglycosylating activity. In some embodiments, the modified sweetener can be substituted or unsubstituted.

In some embodiments, the flavoring comprises one or more sweetness enhancing compounds. Such sweetness enhancing compounds include, but are not limited to, naturally derived compounds, such as hesperitin dihydrochalcone, hesperitin dihydrochalcone-4′-O′glucoside, neohesperitin dihydrochalcone, brazzein, hesperidin, phyllodulcin, naringenin, naringin, phloretin, glucosylated steviol glycosides, (2R,3R)-3-acetoxy-5,7,4′-trihydroxyflavanone, (2R,3R)-3-acetoxy-5,7,3′-trihydroxy-4′-methoxyflavanone, rubusosides, eriodictyol, homoeriodictyol, or synthetic compounds, such as any compounds set forth in U.S. Pat. Nos. 8,541,421; 8,815,956; 9,834,544; 8,592,592; 8,877,922; 9,000,054; and 9,000,051, as well as U.S. Patent Application Publication No. 2017/0119032. As used herein, the term “glucosylated steviol glycoside” refers to the product of enzymatically glucosylating natural steviol glycoside compounds. The glucosylation generally occurs through a glycosidic bond, such as an α-1,2 bond, an α-1,4 bond, an α-1.6 bond, a β-1,2 bond, a β-1,4 bond, a β-1,6 bond, and so forth. In some embodiments of any of the preceding embodiments, the comestible composition comprises 3-((4-amino-2,2-dioxo-1H-benzo[c][1,2,6]thiadiazin-5-yl)oxy)-2,2-dimethyl-N-propyl-propanamide or N-(1-((4-amino-2,2-dioxo-1H-benzo[c][1,2,6]thiadiazin-5-yl)oxy)-2-methyl-propan-2-yl) isonicotinamide.

In some further embodiments, the flavoring comprises one or more umami enhancing compounds. Such umami enhancing compounds include, but are not limited to, naturally derived compounds, or synthetic compounds, such as any compounds set forth in U.S. Pat. Nos. 8,735,081; 8,124,121; and 8,968,708. In some embodiments, the umami-enhancing compound is (2R,4R)-1,2,4-trihydroxy-heptadec-16-ene, (2R,4R)-1,2,4-trihydroxyheptadec-16-yne, or a mixture thereof. In some embodiments, the umami-enhancing compound is (3R,5S)-1-(4-hydroxy-3-methoxyphenyl) decane-3,5-diol diacetate. In some embodiments, the umami-enhancing compound is N-(heptan-4-yl)benzo[d][1,3]dioxole-5-carboxamide.

In some embodiments, the ingestible composition comprises one or more compounds commonly used in savory products. Such flavorings include glutamates (such as MSG), arginates, avocadene, avocadyne, a purine ribonucleitide (such as inosine monophosphate (IMP), guanosine monophosphate (GMP), hypoxanthine, inosine), a yeast extract (as noted above), a fermented food product, cheese, garlic or extracts thereof, a gamma-glutamyl-containing polypeptide, a gamma-glutamyl-containing oligopeptide (such as gamma-glutamyl-containing tripeptides); an flavor-modifying composition (such as a cinnamic acid amide or a derivative thereof), a nucleotide, an oligonucleotide, a plant extract, a food extract, or any combinations thereof.

In some further embodiments, the flavoring comprises one or more cooling enhancing compounds. Such cooling enhancing compounds include, but are not limited to, naturally derived compounds, such as menthol or analogs thereof, or synthetic compounds, such as any compounds set forth in U.S. Pat. Nos. 9,394,287 and 10,421,727.

In some further embodiments, the flavoring comprises one or more bitterness blocking compounds. Such bitterness blocking compounds include, but are not limited to, naturally derived compounds, such as menthol or analogs thereof, or synthetic compounds, such as any compounds set forth in U.S. Pat. Nos. 8,076,491; 8,445,692; and 9,247,759, or in PCT Publication No. WO 2020/033669. In some embodiments, the bitterness blocking compound is 3-(1-((3,5-dimethylisoxazol-4-yl)-methyl)-1H-pyrazol-4-yl)-1-(3-hydroxybenzyl)-imidazolidine-2,4-dione.

In some further embodiments, the flavoring comprises one or more sour taste modulating compounds.

In some further embodiments, the flavoring comprises one or more mouthfeel modifying or mouthfeel enhancing compounds. Such mouthfeel modifying compounds include, but are not limited to, polymethoxylated flavones, tannins, cellulosic materials, bamboo powder, and the like.

In some further embodiments, the flavoring comprises one or more flavor masking compounds. Such flavor masking compounds include, but are not limited to, cellulosic materials, materials extracted from fungus, materials extracted from plants, citric acid, carbonic acid (or carbonates), and the like.

In some embodiments, the flavor-modifying compounds described above are included to improve other tastants that may be present in the comestible composition itself, or that may be included within the flavored products that employ such compositions. Such tastants include sweeteners, umami tastants, kokumi tastants, bitter tastants, sour tastants, and the like.

In some embodiments, the ingestible comprises one or more metal salts or metal complexes, such as iron salts or iron complexes. Such compounds can include any comestible metal salt or complex, such as salts or complexes of calcium, magnesium, sodium, potassium, iron, cobalt, copper, zinc, manganese, molybdenum, and selenium. In some embodiments, the iron compound is an iron salt or an iron complex. In some particular embodiments, the metal compound is a ferrous (Fe²⁺) salt or a ferrous (Fe²⁺) complex. In some embodiments, the metal compound is a ferrous (Fe²⁺) salt, such as ferrous sulfate, ferrous lactate, ferrous fumarate, ferrous gluconate, ferrous succinate, ferrous chloride, ferrous oxalate, ferrous nitrate, ferrous citrate, ferrous ascorbate, ferric citrate, ferric phosphate, or any combination thereof. In some other embodiments, the metal compound is a ferric (Fe³⁺) salt or a ferric (Fe³⁺) complex, such as ferric pyrophosphate. In some embodiments, the iron compound is ferrous lactate, ferrous sulfate, or any combination thereof.

In some embodiments, the iron compound is a heme-containing protein. As used herein, the term “heme containing protein” includes any polypeptide covalently or noncovalently bound to a heme moiety. In some embodiments, the heme-containing polypeptide is a globin and can include a globin fold, which comprises a series of seven to nine alpha helices. Globin type proteins can be of any class (for example, class I, class II, or class III), and in some embodiments, can transport or store oxygen. For example, a heme-containing protein can be a non-symbiotic type of hemoglobin or a leghemoglobin. A heme-containing polypeptide can be a monomer, such as a single polypeptide chain, or can be a dimer, a trimer, tetramer, and/or higher order oligomer. The lifetime of the oxygenated Fe²⁺ state of a heme-containing protein can be similar to that of myoglobin or can exceed it by 10%, or 20%, or 30%>, or 40%, or 50%, or even 100%, or more under conditions in which the heme-protein-containing consumable is manufactured, stored, handled or prepared for consumption.

Non-limiting examples of heme-containing proteins include an androglobin, a cytoglobin, a globin E, a globin X, a globin Y, a hemoglobin, a myoglobin, an erythrocruorin, a beta hemoglobin, an alpha hemoglobin, a protoglobin, a cyanoglobin, a cytoglobin, a histoglobin, a neuroglobins, a chlorocruorin, a truncated hemoglobin (e.g., HbN or HbO), a truncated 2/2 globin, a hemoglobin 3 (e.g., Glb3), a cytochrome, or a peroxidase.

Heme-containing proteins that can be used in the comestible compositions described herein and can be from mammals (for example, farm animals such as cows, goats, sheep, pigs, ox, or rabbits), birds, plants, algae, fungi (for example, yeast or filamentous fungi), ciliates, or bacteria. For example, a heme-containing protein can be from a mammal such as a farm animal (e.g., a cow, goat, sheep, pig, fish, ox, or rabbit) or a bird such as a turkey or chicken. Heme-containing proteins can be from a plant such as Nicotiana tabacum or Nicotiana sylvestris (tobacco); Zea mays (corn), Arabidopsis thaliana, a legume such as Glycine max (soybean), Cicer arietinum (garbanzo or chick pea), Pisum sativum (pea) varieties such as garden peas or sugar snap peas, Phaseolus vulgaris varieties of common beans such as green beans, black beans, navy beans, northern beans, or pinto beans, Vigna unguiculata varieties (cow peas), Vigna radiata (mung beans), Lupinus albus (lupin), or Medicago sativa (alfalfa); Brassica napus (canola), Triticum sps. (wheat, including wheat berries, and spelt); Gossypium hirsutum (cotton); Oryza sativa (rice); Zizania sps. (wild rice); Helianthus annuus (sunflower); Beta vulgaris (sugarbeet); Pennisetum glaucum (pearl millet); Chenopodium sp. (quinoa); Sesamum sp. (sesame); Linum usitatissimum (flax); or Hordeum vulgare (barley). Heme-containing proteins can be isolated from fungi such as Saccharomyces cerevisiae, Pichia pastoris, Magnaporthe oryzae, Fusarium graminearum, Aspergillus oryzae, Trichoderma reesei, Myceliophthora thermophile, Kluyveromyces lactis, or Fusarium oxysporum. Heme-containing proteins can be isolated from bacteria such as Escherichia coli, Bacillus subtilis, Bacillus licheniformis, Bacillus megaterium, Synechocystis sp., Aquifex aeolicus, Methylacidiphilum infernorum, or thermophilic bacteria such as Thermophilus spp. The sequences and structure of numerous heme-containing proteins are known. See, for example, Reedy, et al, Nucleic Acids Research, 2008, Vol. 36, Database issue D307-D313 and the Heme Protein Database available on the world wide web at http://hemeprotein.info/heme.php.

In some embodiments, a non-symbiotic hemoglobin can be from any plant. In some embodiments, a non-symbiotic hemoglobin can be from a plant selected from the group consisting of soybean, sprouted soybean, alfalfa, golden flax, black bean, black eyed pea, northern bean, tobacco, pea, garbanzo, moong bean, cowpeas, pinto beans, pod peas, quinoa, sesame, sunflower, wheat berries, spelt, barley, wild rice, and rice.

In some embodiments, the heme-containing protein is a leghemoglobin, such as a soy, pea, or cowpea leghemoglobin.

Heme-containing or other proteins also can be recombinantly produced using polypeptide expression techniques (e.g., heterologous expression techniques using bacterial cells, insect cells, fungal cells such as yeast, plant cells such as tobacco, soybean, or Arabidopsis, or mammalian cells). For example, leghemoglobin can be recombinantly produced in E. coli or Pichia pastoris. In some cases, standard polypeptide synthesis techniques (such as liquid-phase polypeptide synthesis techniques or solid-phase polypeptide synthesis techniques) can be used to produce heme-containing proteins synthetically. In some cases, in vitro transcription-translation techniques can be used to produce heme-containing proteins.

The heme-containing proteins or iron salts can be used at any suitable concentration. Examples are set forth in PCT Publication No. WO 2015/153666, which is incorporated herein by reference.

The iron compound can make up any suitable weight of the ingestible particle. In some embodiments, the iron compound makes up from 0.1 percent by weight to 10 percent by weight, or from 0.2 percent by weight to 5 percent by weight, or from 0.5 percent by weight to 3 percent by weight, of the ingestible composition, based on the total dry weight of the ingestible composition.

### Other Additives

Various other additives can be included in the ingestible or can be introduced to the ingestible composition as part of the protein additive composition.

For example, in some embodiments, the ingestible composition comprises an emulsifier. Any suitable emulsifier can be used. For example, in some non-limiting embodiments, the emulsifier comprises lecithin, monoglycerides, diglycerides, polysorbates, vegetable oils, and the like. In some embodiments, the emulsifier comprises lecithin. Other examples of emulsifiers can be found in McCutcheon's Emulsifiers & Detergents or the Industrial Surfactants Handbook. The emulsifier can be present in any suitable concentration, which can be adjusted so as to form a stable emulsion of the other components in the comestible composition, for example, when incorporated into a flavored product.

In some instances, it may be desirable to include additives that assist in adjusting the viscosity of the ingestible composition (for example, when the ingestible composition is introduced into water or includes water). Various salts and acids can be used to carry out such adjustments. In some embodiments, the comestible composition or the resulting flavored product comprises one or more salts. Non-limiting examples of suitable salts include magnesium sulfate, sodium chloride, sodium sulfate, calcium chloride, calcium sulfate, potassium sulfate, potassium chloride, potassium sorbate, potassium phosphate, potassium monophosphate, zinc chloride, zinc sulfate, or any mixtures thereof. In some embodiments, the comestible composition or the resulting flavored product also comprises one or more acids, which may be used alone or in combination with the aforementioned salts. Non-limiting examples of suitable acids include citric acid, lactic acid, acetic acid, tartaric acid, succinic acid, ascorbic acid, maleic acid, phosphoric acid, monopotassium phosphate, gluconic acid, glucono-lactone, glucoronic acid, glycyrrhetic acid, folic acid, pantothenic acid or mixtures thereof.

The ingestible compositions can, in certain embodiments, comprise any additional ingredients or combination of ingredients as are commonly used in food and beverage products, including, but not limited to:
acids, including, for example citric acid, phosphoric acid, ascorbic acid, sodium acid sulfate, lactic acid, or tartaric acid;
bitter ingredients, including, for example caffeine, quinine, green tea, catechins, polyphenols, green robusta coffee extract, green coffee extract, potassium chloride, menthol, or proteins (such as proteins and protein isolates derived from plants, algae, or fungi); coloring agents, including, for example caramel color, Red #40, Yellow #5, Yellow #6, Blue #1, Red #3, purple carrot, black carrot juice, purple sweet potato, vegetable juice, fruit juice, beta carotene, turmeric curcumin, or titanium dioxide;
preservatives, including, for example sodium benzoate, potassium benzoate, potassium sorbate, sodium metabisulfate, sorbic acid, or benzoic acid;
antioxidants including, for example ascorbic acid, calcium disodium EDTA, alpha tocopherols, mixed tocopherols, rosemary extract, grape seed extract, resveratrol, or sodium hexametaphosphate;
vitamins or functional ingredients including, for example resveratrol, Co-Q10, omega 3 fatty acids, theanine, choline chloride (citocoline), fibersol, inulin (chicory root), taurine, Panax ginseng extract, guanana extract, ginger extract, L-phenylalanine, L-carnitine, L-tartrate, D-glucuronolactone, inositol, bioflavonoids, Echinacea, ginko biloba, yerba mate, flax seed oil, Garcinia cambogia rind extract, white tea extract, ribose, milk thistle extract, grape seed extract, pyrodixine HCl (vitamin B6), cyanoobalamin (vitamin B12), niacinamide (vitamin B3), biotin, calcium lactate, calcium pantothenate (pantothenic acid), calcium phosphate, calcium carbonate, chromium chloride, chromium polynicotinate, cupric sulfate, folic acid, ferric pyrophosphate, iron, magnesium lactate, magnesium carbonate, magnesium sulfate, monopotassium phosphate, monosodium phosphate, phosphorus, potassium iodide, potassium phosphate, riboflavin, sodium sulfate, sodium gluconate, sodium polyphosphate, sodium bicarbonate, thiamine mononitrate, vitamin D3, vitamin A palmitate, zinc gluconate, zinc lactate, or zinc sulphate;
clouding agents, including, for example ester gun, brominated vegetable oil (BVO), or sucrose acetate isobutyrate (SAIB);
buffers, including, for example sodium citrate, potassium citrate, or salt;
propylene glycol, ethyl alcohol, glycerine, gum Arabic (gum acacia), modified corn starch, silicon dioxide, magnesium carbonate, or tricalcium phosphate; or
starches and stabilizers, including, for example, polysorbate 60, polysorbate 80, medium chain triglycerides, and the like.

In some embodiments, component (a) can further comprise galact-oligosaccharides, fructo-oligosaccharides, acacia fiber, soluble pea fiber, soluble wheat fiber, arabinoxylan, isomalto-oligosaccharides, xylo-oligosaccharides, and the like.

The comestible composition can contain any of a number of ingredients, such as ingredients typically included in meat analogue products.

For example, in some embodiments, the comestible composition comprises a flavored water-in-oil emulsion according to any of the embodiments set forth in PCT Publication No. WO 2020/260628, which is hereby incorporated by reference.

In some embodiments, the comestible composition comprises encapsulated flavor compositions according to any of the embodiments set forth in PCT Publication No. WO 2021/104846, which is hereby incorporated by reference.

In some embodiments, the ingestible composition further comprises a carrier and, optionally, at least one adjuvant. The term “carrier” denotes a usually inactive accessory substance, such as solvents, binders, bulking agents, or other inert medium, which is used in combination with the present compound and one or more optional adjuvants to form the formulation. For example, water or starch can be a carrier for a flavored product. In some embodiments, the carrier is the same as the diluting medium for reconstituting the flavored product; and in other embodiments, the carrier is different from the diluting medium. The term “carrier” as used herein includes, but is not limited to, comestibly acceptable carrier.

The term “adjuvant” denotes an additive which supplements, stabilizes, maintains, or enhances the intended function or effectiveness of the active ingredient, such as the compound of the present invention. In one embodiment, the at least one adjuvant comprises one or more flavoring agents. The flavoring agent may be of any flavor known to one skilled in the art or consumers, such as the flavor of chocolate, coffee, tea, mocha, French vanilla, peanut butter, chai, or combinations thereof. In another embodiment, the at least one adjuvant comprises one or more ingredients selected from the group consisting of a emulsifier, a stabilizer, an antimicrobial preservative, an antioxidant, vitamins, minerals, fats, starches, protein concentrates and isolates, salts, and combinations thereof. Examples of emulsifiers, stabilizers, antimicrobial preservatives, antioxidants, vitamins, minerals, fats, starches, protein concentrates and isolates, and salts are described in U.S. Pat. No. 6,468,576, the content of which is hereby incorporated by reference in its entirety for all purposes.

The ingestible composition may further comprise a freezing point depressant, nucleating agent, or both as the at least one adjuvant. The freezing point depressant is an ingestibly acceptable compound or agent which can depress the freezing point of a liquid or solvent to which the compound or agent is added. That is, a liquid or solution containing the freezing point depressant has a lower freezing point than the liquid or solvent without the freezing point depressant. In addition to depress the onset freezing point, the freezing point depressant may also lower the water activity of the flavored product. The examples of the freezing point depressant include, but are not limited to, carbohydrates, oils, ethyl alcohol, polyol, e.g., glycerol, and combinations thereof. The nucleating agent denotes an ingestibly acceptable compound or agent which is able to facilitate nucleation. The presence of nucleating agent in the flavored product can improve the mouthfeel of the frozen Blushes of a frozen slush and to help maintain the physical properties and performance of the slush at freezing temperatures by increasing the number of desirable ice crystallization centers. Examples of nucleating agents include, but are not limited to, calcium silicate, calcium carbonate, titanium dioxide, and combinations thereof.

In some embodiments, the ingestible composition is formulated to have a low water activity for extended shelf life. Water activity is the ratio of the vapor pressure of water in a formulation to the vapor pressure of pure water at the same temperature. In one embodiment, the ingestible composition has a water activity of less than about 0.85. In another embodiment, the ingestible composition has a water activity of less than about 0.80. In another embodiment, the ingestible composition has a water activity of less than about 0.75.

### Methods of Preparation

The ingestible compositions disclosed herein can be made by any suitable means, as typically employed in the manufacturing of products containing fiber blends. Such methods include dry mixing, granulating, encapsulating, spray drying, and the like. In some embodiments, the ingestible compositions are prepared by spray drying, where the protein compositions are mixed with a liquid medium that is removed by drying during a spraying process. Spray drying processes are well known in the art of preparing comestible products. Any suitable spray-drying process can be used and optimized for the components used in the ingestible compositions. In some embodiments, the ingestible compositions are prepared by extrusion, where the protein compositions are mixed with other materials and is formed into an shaped article by extrusion. Extrusion processes are well known in the art of preparing comestible products. Any suitable extrusion process or apparatus can be used and optimized for the components used in the ingestible compositions.

### Flavored Products

In certain aspects, the disclosure provides a flavored product, which comprises the ingestible composition according to any of the embodiments set forth above. In some embodiments, the flavored product is a food product, such as a meat analogue product, for example, a non-animal-based ground beef replica. In some other embodiments, the flavored product is an animal feed product, such as pet food product. In such flavored products, the comestible composition can, in some embodiments, be used in combination with animal-based products to reduce the degree of animal fats or animal products in the comestible product. In other embodiments, the flavored products contain no animal-based products, such that the comestible composition is used to make an analogue or a replica of a meat product, such as a ground beef patty.

In some other embodiments, the flavored product is a meat-replacement product (or meat analogue), such as a product designed to mimic products traditionally made from red meat. For example, the flavored product can be a meat analogue dough, such as those described in PCT Publication No. WO 2015/153666. Such flavored products can be designed to simulate beef products, such as ground beef (for making burgers) or cuts of beef for inclusion in soups, prepared meals, and the like. The flavored products can also be designed to simulate cuts or ground forms of other meat, such as chicken, turkey, pork, goat, lamb, venison, and bison, or seafood, such as fish or shellfish (crab, scallop, shrimp, squid, and the like).

### EXAMPLES

To further illustrate this invention, the following examples are included. The examples should not, of course, be construed as specifically limiting the invention. Variations of these examples within the scope of the claims are within the purview of one skilled in the art and are considered to fall within the scope of the invention as described, and claimed herein. The reader will recognize that the skilled artisan, armed with the present disclosure, and skill in the art is able to prepare and use the invention without exhaustive examples.

### Example 1—Pea Protein and Red Lentil Protein

Five samples were prepared having different combinations of pea protein and red lentil protein, and various other additives. The ingredients were mixed, and shaped into bars, which can be used for sensory evaluation. The samples are as follows:
Sample 1A: pea protein (42 wt %); water (58 wt %);
Sample 1B: pea protein (32 wt %); red lentil protein (10 wt %); water (58 wt %);
Sample 1C: pea protein (37 wt %); red lentil protein (5 wt %); water (58 wt %);
Sample 1D: pea protein (37 wt %); red lentil protein (5 wt %); water (58 wt %); mouthfeel enhancer (0.5 wt %);
Sample 1E: pea protein (37 wt %); red lentil protein (5 wt %); water (58 wt %); vegetable protein masker (0.4 wt %).

Table 1 presents the results from sensory evaluation, in which 8-10 sensory panelists were asked to evaluate the five samples on a number of characteristics on a scale from 1 to 10, where a higher number indicates greater intensity of the characteristic. As used in this example and other examples, the mouthfeel enhancer is 513475 2CB MODULASENSE tasty flavor (Firmenich SA, Satigny, Switzerland), and the vegetable protein masker is 864832 3CB flavor masker (Firmenich SA, Satigny, Switzerland).

TABLE 1

| | 1A | 1B | 1C | 1D | 1E |
|---|---|---|---|---|---|
| Green (pea) aroma intensity | 4.0 | 4.3 | 3.5 | 3.7 | 2.4 |
| Saltiness | 4.1 | 4.0 | 3.8 | 4.2 | 4.2 |
| Astringency | 1.0 | 1.3 | 1.3 | 1.0 | 1.1 |
| Juiciness | 2.9 | 2.4 | 2.8 | 4.6 | 4.7 |
| Sweetness | 1.4 | 1.8 | 1.8 | 1.8 | 2.1 |
| Bitterness | 0.4 | 0.2 | 0.3 | 0.4 | 0.3 |
| Green (pea) taste intensity | 3.7 | 3.9 | 3.2 | 3.2 | 2.9 |
| Cereal flavor intensity | 2.8 | 3.1 | 2.8 | 2.3 | 2.5 |
| Texture | 3.7 | 3.0 | 3.5 | 3.4 | 3.5 |
| Overall liking | 3.6 | 2.7 | 3.8 | 4.2 | 5.0 |

### Example 2—Pea Protein and Fava Bean Protein

Five samples were prepared having different combinations of pea protein and fava bean protein, and various other additives. The ingredients were mixed, and shaped into bars, which can be used for sensory evaluation. The samples are as follows:
Sample 2A: pea protein (42 wt %); water (58 wt %);
Sample 2B: pea protein (32 wt %); fava bean protein (10 wt %); water (58 wt %);
Sample 2C: pea protein (37 wt %); fava bean protein (5 wt %); water (58 wt %);
Sample 2D: pea protein (37 wt %); fava bean protein (5 wt %); water (58 wt %); mouthfeel enhancer (0.5 wt %);
Sample 2E: pea protein (37 wt %); fava bean protein (5 wt %); water (58 wt %); vegetable protein masker (0.4 wt %).

Table 2 presents the results from sensory evaluation, in which 8-10 sensory panelists were asked to evaluate the five samples on a number of characteristics on a scale from 1 to 10, where a higher number indicates greater intensity of the characteristic.

TABLE 2

| | 2A | 2B | 2C | 2D | 2E |
|---|---|---|---|---|---|
| Green (pea) aroma intensity | 2.2 | 3.7 | 2.2 | 1.5 | 1.3 |
| Saltiness | 4.1 | 4.3 | 4.1 | 4.3 | 4.2 |
| Astringency | 1.1 | 1.2 | 1.5 | 1.3 | 0.5 |
| Juiciness | 3.2 | 3.2 | 3.0 | 2.9 | 3.5 |
| Sweetness | 1.7 | 2.3 | 1.4 | 2.0 | 1.8 |
| Bitterness | 0.6 | 1.5 | 0.8 | 1.0 | 0.3 |
| Green (pea) taste intensity | 2.9 | 3.5 | 2.5 | 1.8 | 1.2 |
| Cereal flavor intensity | 1.8 | 2.8 | 2.5 | 1.7 | 1.4 |
| Texture | 3.3 | 3.2 | 2.7 | 3.3 | 3.5 |
| Overall liking | 4.0 | 2.7 | 3.5 | 4.3 | 5.4 |

### Example 3—Pea Protein and Sunflower Protein

Four samples were prepared having different combinations of pea protein and sunflower protein, and various other additives. The ingredients were mixed, and shaped into bars, which can be used for sensory evaluation. The samples are as follows:
Sample 3A: pea protein (42 wt %); water (58 wt %);
Sample 3B: pea protein (37 wt %); sunflower protein (5 wt %); water (58 wt %);
Sample 3C: pea protein (37 wt %); sunflower protein (5 wt %); water (58 wt %); mouthfeel enhancer (0.5 wt %);
Sample 3D: pea protein (37 wt %); sunflower protein (5 wt %); water (58 wt %); vegetable protein masker (0.4 wt %).

Table 3 presents the results from sensory evaluation, in which 8-10 sensory panelists were asked to evaluate the four samples on a number of characteristics on a scale from 1 to 10, where a higher number indicates greater intensity of the characteristic.

TABLE 3

| | 3A | 3B | 3C | 3D |
|---|---|---|---|---|
| Green (pea) aroma intensity | 4.0 | 2.0 | 1.8 | 2.1 |
| Saltiness | 4.1 | 4.0 | 4.0 | 4.3 |
| Astringency | 2.2 | 1.0 | 1.6 | 1.6 |
| Juiciness | 3.3 | 4.0 | 4.0 | 4.3 |
| Sweetness | 1.5 | 1.7 | 2.3 | 1.9 |
| Bitterness | 1.0 | 0.1 | 0.5 | 0.3 |
| Green (pea) taste intensity | 3.3 | 2.3 | 1.4 | 2.0 |
| Cereal flavor intensity | 2.7 | 1.4 | 1.7 | 1.5 |
| Texture | 4.2 | 3.6 | 3.4 | 3.3 |
| Overall liking | 3.0 | 4.5 | 4.1 | 4.7 |

### Example 4—Pea Protein and Mung Bean Protein

Three samples were prepared having different combinations of pea protein and mung bean protein, and various other additives. The ingredients were mixed, and shaped into bars, which can be used for sensory evaluation. The samples are as follows:
Sample 4A: pea protein (50 wt %); water (50 wt %);
Sample 4B: pea protein (42.5 wt %); mung bean protein (7.5 wt %); water (50 wt %);
Sample 4C: pea protein (35 wt %); mung bean protein (15 wt %); water (50 wt %).

Table 4 presents the results from sensory evaluation, in which 8-10 sensory panelists were asked to evaluate the three samples on a number of characteristics on a scale from 1 to 10, where a higher number indicates greater intensity of the characteristic.

TABLE 4

| | 4A | 4B | 4C |
|---|---|---|---|
| Green (pea) aroma intensity | 5.2 | 3.6 | 3.8 |
| Saltiness | 5.2 | 4.8 | 4.9 |
| Astringency | 0.8 | 0.5 | 0.6 |
| Juiciness | 4.0 | 4.2 | 4.4 |
| Sweetness | 1.4 | 2.0 | 2.0 |
| Bitterness | 1.3 | 0.6 | 0.6 |
| Green (pea) taste intensity | 5.2 | 3.8 | 3.2 |
| Cereal flavor intensity | 2.7 | 1.4 | 1.7 |
| Beany Flavor | 4.2 | 2.6 | 2.8 |
| Texture | 3.1 | 2.8 | 1.9 |
| Overall liking | 3.6 | 4.0 | 4.7 |

### Example 5—Pea Protein and Oat Protein

Three samples were prepared having different combinations of pea protein and oat protein, and various other additives. The ingredients were mixed, and shaped into bars, which can be used for sensory evaluation. The samples are as follows:
Sample 5A: pea protein (42 wt %); water (58 wt %);
Sample 5B: pea protein (35.6 wt %); oat protein (6.6 wt %); water (58 wt %);
Sample 5C: pea protein (29.4 wt %); oat protein (12.6 wt %); water (58 wt %).

Table 5 presents the results from sensory evaluation, in which 8-10 sensory panelists were asked to evaluate the three samples on a number of characteristics on a scale from 1 to 10, where a higher number indicates greater intensity of the characteristic.

TABLE 5

| | 5A | 5B | 5C |
|---|---|---|---|
| Green (pea) aroma intensity | 4.6 | 3.6 | 4.0 |
| Saltiness | 3.9 | 3.6 | 3.1 |
| Sweetness | 2.8 | 2.3 | 3.3 |
| Juiciness | 3.0 | 2.9 | 2.8 |
| Green (pea) taste intensity | 3.7 | 3.4 | 3.5 |
| Rancidity | 0.8 | 0.7 | 1.2 |
| Malty/caramel taste | 2.2 | 1.7 | 2.2 |
| Cardboard taste | 2.1 | 2.1 | 1.9 |
| Cereal savory taste | 4.7 | 4.6 | 5.0 |
| Texture | 3.6 | 3.7 | 3.1 |
| Overall liking | 3.3 | 3.4 | 3.1 |

### Example 6—Soy Protein and Fava Bean Protein

Four samples were prepared having different combinations of soy protein and fava bean protein, and various other additives. The ingredients were mixed, and shaped into bars, which can be used for sensory evaluation. The samples are as follows:
Sample 6A: soy protein (40 wt %); water (60 wt %);
Sample 6B: soy protein (40 wt %); water (60 wt %); savory flavor (0.5%)
Sample 6C: soy protein (35 wt %); fava bean protein (5 wt %); water (60 wt %);
Sample 6D: soy protein (35 wt %); fava bean protein (5 wt %); water (60 wt %); savory flavor (0.5 wt %).

Table 6 presents the results from sensory evaluation, in which 8-10 sensory panelists were asked to evaluate the four samples on a number of characteristics on a scale from 1 to 10, where a higher number indicates greater intensity of the characteristic.

TABLE 6

| | 6A | 6B | 6C | 6D |
|---|---|---|---|---|
| Green aroma intensity | 3.0 | 3.2 | 3.2 | 3.0 |
| Saltiness | 4.0 | 4.0 | 4.5 | 4.7 |
| Astringency | 3.0 | 2.2 | 3.5 | 2.1 |
| Juiciness | 2.1 | 3.1 | 2.4 | 3.1 |
| Sweetness | 1.8 | 2.2 | 1.8 | 2.4 |
| Bitterness | 0.7 | 0.7 | 1.1 | 0.7 |
| Green taste intensity | 3.2 | 2.5 | 2.5 | 2.2 |
| Cereal flavor intensity | 2.4 | 2.4 | 2.7 | 2.4 |
| Texture | 4.7 | 4.6 | 4.6 | 4.6 |
| Overall liking | 2.6 | 4.0 | 3.8 | 4.4 |

### Example 7—Soy Protein and Red Lentil Protein

Four samples were prepared having different combinations of soy protein and red lentil protein, and various other additives. The ingredients were mixed, and shaped into bars, which can be used for sensory evaluation. The samples are as follows:
Sample 7A: soy protein (40 wt %); water (60 wt %);
Sample 7B: soy protein (40 wt %); water (60 wt %); savory flavor (0.5%)
Sample 7C: soy protein (35 wt %); red lentil protein (5 wt %); water (60 wt %);
Sample 7D: soy protein (35 wt %); red lentil protein (5 wt %); water (60 wt %); savory flavor (0.5 wt %).

Table 7 presents the results from sensory evaluation, in which 8-10 sensory panelists were asked to evaluate the four samples on a number of characteristics on a scale from 1 to 10, where a higher number indicates greater intensity of the characteristic.

TABLE 7

| | 7A | 7B | 7C | 7D |
|---|---|---|---|---|
| Green aroma intensity | 3.0 | 2.9 | 3.0 | 2.2 |
| Saltiness | 4.5 | 4.5 | 4.5 | 4.5 |
| Astringency | 2.4 | 1.2 | 2.2 | 1.0 |
| Juiciness | 3.5 | 3.0 | 2.9 | 3.5 |
| Sweetness | 1.2 | 1.4 | 1.4 | 1.9 |
| Bitterness | 1.2 | 0.4 | 1.0 | 0.4 |
| Green taste intensity | 3.7 | 2.2 | 3.0 | 2.1 |
| Cereal flavor intensity | 1.3 | 0.9 | 1.4 | 0.9 |
| Texture | 4.9 | 4.9 | 4.7 | 4.2 |
| Overall liking | 3.8 | 5.0 | 3.8 | 5.0 |

### Example 8—Soy Protein and Oat Protein

Four samples were prepared having different combinations of soy protein and oat protein, and various other additives. The ingredients were mixed, and shaped into bars, which can be used for sensory evaluation. The samples are as follows:
Sample 8A: soy protein (40 wt %); water (60 wt %);
Sample 8B: soy protein (40 wt %); water (60 wt %); savory flavor (0.5%)
Sample 8C: soy protein (35 wt %); oat protein (5 wt %); water (60 wt %);
Sample 8D: soy protein (35 wt %); oat protein (5 wt %); water (60 wt %); savory flavor (0.5 wt %).

Table 8 presents the results from sensory evaluation, in which 8-10 sensory panelists were asked to evaluate the four samples on a number of characteristics on a scale from 1 to 10, where a higher number indicates greater intensity of the characteristic.

TABLE 8

| | 8A | 8B | 8C | 8D |
|---|---|---|---|---|
| Green aroma intensity | 2.8 | 2.5 | 2.5 | 2.0 |
| Saltiness | 3.1 | 3.7 | 3.1 | 3.7 |
| Astringency | 2.3 | 1.0 | 1.5 | 1.5 |
| Juiciness | 1.8 | 1.0 | 1.6 | 1.4 |
| Sweetness | 2.6 | 2.4 | 2.4 | 2.6 |
| Bitterness | 2.4 | 1.9 | 1.9 | 2.0 |
| Green taste intensity | 1.8 | 0.7 | 0.7 | 1.0 |
| Cereal flavor intensity | 4.0 | 2.7 | 3.0 | 2.2 |
| Texture | 3.9 | 2.2 | 3.0 | 2.7 |
| Overall liking | 4.7 | 3.9 | 3.5 | 4.1 |

### Example 9—Pea Protein and Canola Protein

Three samples were prepared having different combinations of pea protein and canola protein, and various other additives. The ingredients were mixed, and shaped into bars, which can be used for sensory evaluation. The samples are as follows:
Sample 9A: pea protein (40 wt %); water (60 wt %);
Sample 9B: pea protein (35 wt %); canola protein (5 wt %); water (60 wt %);
Sample 9C: soy protein (35 wt %); oat protein (5 wt %); water (60 wt %); vegetable protein masker (0.5 wt %).

Table 9 presents the results from sensory evaluation, in which 8-10 sensory panelists were asked to evaluate the three samples on a number of characteristics on a scale from 1 to 10, where a higher number indicates greater intensity of the characteristic.

TABLE 9

| | 9A | 9B | 9C |
|---|---|---|---|
| Green aroma intensity | 5.1 | 4.3 | 4.1 |
| Astringency | 1.9 | 1.6 | 1.9 |
| Juiciness | 3.4 | 4.0 | 2.9 |
| Bitterness | 1.7 | 1.4 | 1.1 |
| Green taste intensity | 5.3 | 4.0 | 4.3 |
| Cereal flavor intensity | 3.0 | 3.1 | 3.4 |
| Hardness | 4.1 | 4.0 | 5.8 |
| Chewiness | 4.1 | 4.6 | 5.5 |
| Stickiness | 3.5 | 3.3 | 2.9 |
| Crumbliness | 2.3 | 3.0 | 2.3 |

1. Use of a protein additive composition to improve the flavor or aroma of, or to improve the amino acid profile of, an ingestible composition;
wherein the ingestible composition comprises pea protein, soy protein, or a combination thereof; and
wherein the protein additive composition comprises at least one non-animal protein besides pea protein or soy protein.

2. The use of claim 1, wherein the use is to improve the flavor or aroma of the ingestible composition.

3. The use of claim 1, wherein the use is to improve the amino acid profile of the ingestible composition.

4. The use of any one of claims 1 to 3, wherein the at least one non-animal protein besides pea protein or soy protein is fava bean protein, mung bean protein, sunflower seed protein, red lentil protein, oat protein, canola protein, or any combinations thereof.

5. The use of claim 4, wherein the weight ratio of pea or soy protein relative to the at least one non-animal protein besides pea protein or soy protein ranges from 1:1 to 20:1.

6. The use of any one of claims 1 to 5, wherein the protein additive composition comprises a fiber, such as a plant-derived fiber.

7. The use of any one of claims 1 to 6, wherein the protein additive composition further comprises a flavoring.

8. An ingestible composition, which comprises:
(a) pea protein, soy protein, or a combination thereof;
(b) at least one additional non-animal protein; and
(c) optionally, a flavoring.

9. The ingestible composition of claim 8, wherein the at least one non-animal protein besides pea protein or soy protein is fava bean protein, mung bean protein, sunflower seed protein, red lentil protein, oat protein, or any combinations thereof.

10. The ingestible composition of claim 8 or 9, wherein the weight ratio of pea or soy protein relative to the at least one non-animal protein besides pea protein or soy protein ranges from 1:1 to 20:1.

11. The ingestible composition of any one of claims 8 to 10, wherein the protein additive composition comprises a fiber, such as a plant-derived fiber.

12. The ingestible composition of any one of claims 8 to 11, wherein the protein additive composition further comprises a flavoring.

13. A flavored product comprising an ingestible composition of any one of claims 8 to 12.

14. The flavored product of claim 13, wherein the flavored product is a beverage product, such as a dairy or dairy analogue product, or a food product, such as yogurt or a meat analogue product, such as a chicken analogue product, a beef analogue product, or the like.
